(19) United States
(12) Patent Application Publication
(10) Pub. No.: US 2026/0217272 A1
(43) Pub. Date: Jul. 30, 2026

(54) VEHICLE CONTROL DEVICE

(71) Applicant: TOYOTA JIDOSHA KABUSHIKI KAISHA, Toyota-shi (JP)

(72) Inventors: Ryosuke TANIMURA, Nagoya-shi (JP); Aika Miyajima, Nagoya-shi (JP); Akari Yamada, Nagoya-shi (JP); Reina Yamamura, Nagoya-shi (JP)

(73) Assignee: TOYOTA JIDOSHA KABUSHIKI KAISHA, Toyota-shi (JP)

(21) Appl. No.: 19/411,996

(22) Filed: Dec. 8, 2025

(30) Foreign Application Priority Data
Jan. 28, 2025 (JP) 2025-012418

(51) Int. Cl. B60W 60/00; B60J 3/04; B60W 30/06

(52) U.S. Cl. CPC B60W 60/001; B60J 3/04; B60W 30/06

(57) ABSTRACT

A vehicle control device includes a processor, in which the processor is configured to, in a case in which a first signal indicating that a debt for a vehicle is not correctly paid is received, restrict some of functions of the vehicle in response to the reception of the first signal.

### CROSS-REFERENCE TO RELATED APPLICATION

This application claims priority to Japanese Patent Application No. 2025-012418 filed on January 28, 2025. The disclosure of the above-identified application, including the specification, drawings, and claims, is incorporated by reference herein in its entirety.

### BACKGROUND

### 1. Technical Field

The present disclosure relates to a vehicle control device.

### 2. Description of Related Art

In Japanese Patent No. 7050844 (JP 7050844 B), a technology of imposing a restriction on traveling of a vehicle based on payment information related to a payment status of a loan is disclosed.

### SUMMARY

Meanwhile, since creditors of a car lease or a car loan prefer receiving payments over restricting use of the vehicle, the creditors want to encourage debtors to make payments smoothly.

However, in the technology disclosed in JP 7050844 B, it is insufficient to prompt the debtor to make the payment because only notification related to the payment status of the loan or a delay of the loan, or notification for prompting the payment is used, and there is room for improvement.

The present disclosure has been made in view of the above, and an object thereof is to provide a vehicle control device capable of prompting a debtor to make a payment for a debt.

A vehicle control device according to the present disclosure includes a processor configured to perform, in a case where a first signal indicating that a debt for a target vehicle configured to perform autonomous driving is not correctly paid is received from a debt management server that manages the debt for the target vehicle, control in response to reception of the first signal such that the target vehicle is stopped or parked at a position a predetermined distance away from a destination designated for the target vehicle.

In addition, a vehicle control device according to the present disclosure includes a processor configured to restrict, in a case where a first signal indicating that a debt for a target vehicle configured to perform autonomous driving is not correctly paid is received, some of functions of the target vehicle in response to reception of the first signal.

According to the present disclosure, an effect of prompting a debtor to make a payment for a debt is obtained.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram showing a schematic configuration of a vehicle control system according to Embodiment 1 of the present disclosure;

FIG. 2 is a sequence diagram showing an example of an exchange of information between a debt collection server, a debt management server, a vehicle information server, and a vehicle according to Embodiment 1 of the present disclosure;

FIG. 3 is a flowchart showing an outline of processing executed by the debt collection server according to Embodiment 1 of the present disclosure;

FIG. 4 is a flowchart showing an outline of processing executed by the vehicle information server according to Embodiment 1 of the present disclosure;

FIG. 5 is a flowchart showing an outline of processing executed by the vehicle according to Embodiment 1 of the present disclosure; and

FIG. 6 is a flowchart showing an outline of processing executed by the debt collection server according to Embodiment 2 of the present disclosure.

### DETAILED DESCRIPTION OF EMBODIMENTS

Hereinafter, a vehicle control device according to the embodiment of the present disclosure will be described with reference to the drawings. It should be noted that components in the following embodiments include those that can be replaced and easily implemented by those skilled in the art or substantially the same.

### Embodiment 1

### Vehicle Control System

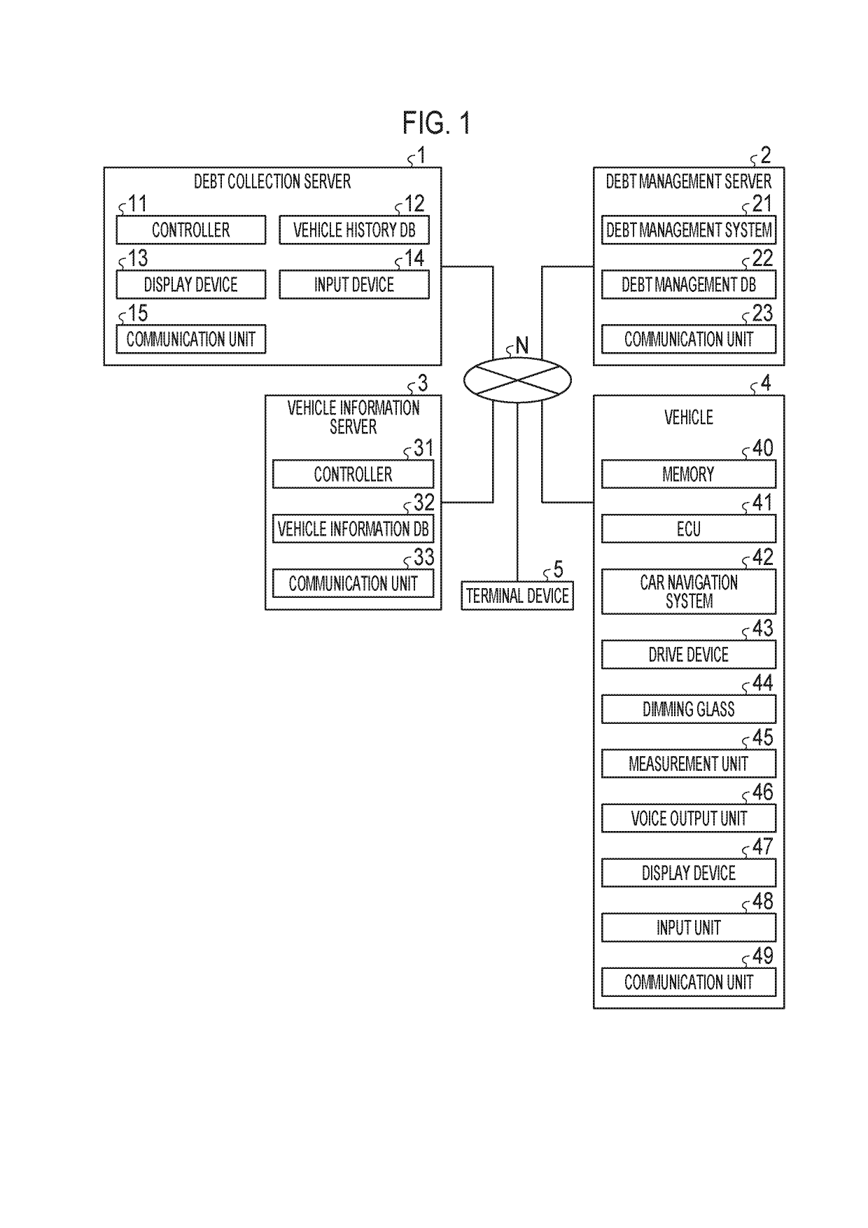

FIG. 1 is a block diagram showing a schematic configuration of a vehicle control system according to Embodiment 1. A vehicle control system 100 shown in FIG. 1 includes a debt collection server 1, a debt management server 2, a vehicle information server 3, a vehicle 4, and a terminal device 5. The debt collection server 1, the debt management server 2, the vehicle information server 3, the vehicle 4, and the terminal device 5 all include a communication function and are configured to communicate with each other through a network N and exchange various types of information. The network N is configured by, for example, a public line network such as an Internet line network or a mobile phone line network.

In addition, in Embodiment 1, examples of the "debt" include a debt related to a contract for installment purchase of the vehicle, a debt related to a lease contract of the vehicle 4, a debt related to a subscription contract of the vehicle 4, and a debt related to a rental car contract of the vehicle 4.

In addition, the creditor in Embodiment 1 is, for example, a holder (owner) of the vehicle 4. Specifically, examples of the creditor include a dealer that sells the vehicle 4, a finance company, and a bank. In addition, the debtor in Embodiment 1 is, for example, a user of the vehicle 4. Specifically, examples of the debtor include a purchaser of the vehicle 4 and a contracting party of a lease contract or the like, and a business company.

### Functional Configuration of Debt Collection Server

First, a functional configuration of the debt collection server 1 will be described. The debt collection server 1 remotely controls an operation of the vehicle 4 to collect the creditor related to the vehicle 4. As shown in FIG. 1, the debt collection server 1 includes a controller 11, a vehicle history database (DB) 12, a display device 13, an input device 14, and a communication unit 15.

The controller 11 is realized by, for example, a processor consisting of a central processing unit (CPU) or the like and a memory (main storage unit) consisting of a random access memory (RAM), a read only memory (ROM), or the like.

The vehicle history DB 12 is a database that is configured by using a hard disk drive (HDD), a solid state drive (SSD), or the like, and that accumulates various types of information related to the vehicle 4. The vehicle history DB 12 acquires, for example, the usage status information from the vehicle information server 3 and accumulates the usage status information in association with a vehicle identification number (VIN number) or the like. In addition, the vehicle history DB 12 accumulates, for example, steady stop position information that is information related to a position where the vehicle 4 is stopped or parked in a steady or daily manner and that is created based on the position information periodically transmitted from the vehicle 4.

The display device 13 is realized by, for example, a liquid crystal display (LCD) or an organic EL display (OLED). The display device 13 displays various types of information under the control of the controller 11.

The input device 14 is realized by, for example, a touch panel, a keyboard, or a pointing device. The input device 14 receives an input of various operations by the user and outputs a signal corresponding to the received operation to the controller 11.

The communication unit 15 is configured by, for example, a local area network (LAN) interface board or a wireless communication circuit for wireless communication. The communication unit 15 exchanges information with the debt management server 2 and the vehicle information server 3 by communication through the network N under the control of the controller 11.

### Functional Configuration of Debt Management Server

Next, a functional configuration of the debt management server 2 will be described. The debt management server 2 manages the debt related to the vehicle 4. The debt management server 2 includes a debt management system 21, a debt management DB 22, and a communication unit 23.

In a case in which there is the vehicle 4 (target vehicle) that satisfies an engine start lock requirement among the vehicles 4 managed by the debt management DB 22, the debt management system 21 transmits information (for example, a vehicle identification number (VIN number)) for specifying the vehicle 4 to the debt collection server 1. Here, the vehicle 4 (target vehicle) that satisfies the engine start lock requirement is the vehicle 4 (target vehicle) in which a delay in payment or the like in the debt by the debtor has occurred, the vehicle 4 (target vehicle) in which the debt is not correctly paid, and the vehicle 4 in which default or a delay in debt performance has occurred.

The debt management DB 22 manages information for specifying each of the vehicles 4 and information related to the debt of the vehicle 4 in association with each other. Here, the information for specifying each of the vehicles 4 is, for example, a vehicle identification number (VIN number). In addition, the information related to the debt of the vehicle 4 is, for example, repayment information indicating a payment status of a loan debt or a lease debt.

The communication unit 23 is configured by, for example, a LAN interface board or a wireless communication circuit for wireless communication. The communication unit 23 exchanges information with the debt collection server 1 by communication through the network N.

### Functional Configuration of Vehicle Information Server

Next, a functional configuration of the vehicle information server 3 will be described. The vehicle information server 3 acquires the usage status information from the vehicle 4 in response to a request from the debt collection server 1 and transmits the acquired usage status information to the debt collection server 1. The vehicle information server 3 includes a controller 31, a vehicle information DB 32, and a communication unit 33.

The controller 31 is realized by, for example, a processor consisting of a CPU or the like and a memory (main storage unit) consisting of a RAM, a ROM, or the like. The controller 31 acquires the usage status information from the vehicle 4 in response to a request from the debt collection server 1 and transmits the acquired usage status information to the debt collection server 1.

The vehicle information DB 32 accumulates the usage status information acquired from the vehicle 4 (target vehicle) and the information (for example, a vehicle identification number (VIN number)) for specifying the vehicle 4 in association with each other. The vehicle information DB 32 transmits the usage status information to the debt collection server 1 under the control of the controller 31 in response to a request from the debt collection server 1.

The communication unit 33 is configured by, for example, a LAN interface board or a wireless communication circuit for wireless communication. The communication unit 33 exchanges information with the debt collection server 1, the debt management server 2, and the vehicle 4 by communication through the network N.

### Function Configuration of Vehicle

Next, a functional configuration of the vehicle 4 will be described. The vehicle 4 is, for example, a general engine vehicle (CONV: Conventional Vehicle), a hybrid electric vehicle (HEV), or a plug-in hybrid electric vehicle (PHEV). In addition, the vehicle 4 may be, for example, a fuel cell electric vehicle (FCEV) or a battery electric vehicle (BEV). Further, it is assumed that the vehicle 4 is capable of autonomous driving, and is configured to autonomously move to a destination or a pickup and drop-off location input from the debt collection server 1 or the terminal device 5.

The vehicle 4 includes a memory 40, an ECU 41, a car navigation system 42, a drive device 43, a dimming glass 44, a measurement unit 45, a voice output unit 46, a display device 47, an input unit 48, and a communication unit 49.

The memory 40 records various types of information related to the vehicle 4, a program executed by the ECU 41, and two-dimensional (2D) map information or three-dimensional (3D) map information used by the car navigation system 42. In addition, the memory 40 is configured by using an HDD, an SSD, or the like.

The ECU 41 is an electronic control unit (ECU) in which a microcomputer consisting of, for example, a CPU, a ROM, and a RAM is a main component. The ECU 41 receives predetermined information from the vehicle information server 3 in a case in which a requirement (hereinafter, referred to as a "function lock requirement") for restricting some of functions of the vehicle 4 provided in the vehicle 4 is satisfied, and restricts some of functions of the vehicle 4 based on the information. Here, the "function lock requirement" includes, for example, a case in which the debtor of the vehicle 4 is in default (for example, a payment delay). The determination as to whether the function lock requirement is satisfied is performed by, for example, the debt management server 2. In a case in which there is the vehicle 4 (target vehicle) that satisfies the function lock requirement, information (for example, a vehicle identification number (VIN number)) for specifying the vehicle 4 is transmitted from the debt management server 2 to the vehicle 4 via the debt collection server 1 and the vehicle information server 3. The target vehicle refers to, for example, the vehicle 4 that is the debt target.

In addition, for the vehicle 4 that is function-locked, the ECU 41 releases the function restriction of the vehicle 4 in a case in which a predetermined condition, for example, a second signal indicating that the debt of the vehicle 4 is performed is received.

In addition, the ECU 41 restricts some of functions of the vehicle 4 in a case in which a first signal (hereinafter, simply referred to as a "first signal") indicating that the debt for the vehicle 4 (target vehicle) is not correctly paid is received from the vehicle information server 3. Further, the ECU 41 maintains the function restriction of the vehicle 4 until the second signal (hereinafter, simply referred to as a "second signal") indicating that the debt for the vehicle 4 (target vehicle) is performed is received from the vehicle information server 3. In addition, in Embodiment 1, the ECU 41 functions as a processor of the vehicle control device.

Further, the ECU 41 controls the drive device 43 and autonomously moves the vehicle 4 toward a destination or a pickup and drop-off location designated via the terminal device 5 or the input unit 48 based on the position information of the vehicle 4 detected by the car navigation system 42.

The car navigation system 42 detects a current position of the vehicle 4 by, for example, receiving radio waves from a global positioning system (GPS) satellite. It should be noted that the method of detecting the current position of the vehicle 4 is not limited to a method using the GPS satellite, and for example, a method of combining light detection and ranging or laser imaging detection and ranging (LiDAR) and two-dimensional or three-dimensional map information recorded in the memory 40 may be used.

The drive device 43 is configured by using a drive source such as an engine and a motor, a brake mechanism, a steering operation mechanism, and the like, and moves the vehicle 4. In addition, the drive device 43 autonomously drives under the control of the ECU 41 to move the vehicle 4 to the destination based on the position information of the vehicle 4 detected by the car navigation system 42.

The dimming glass 44 is provided in a window of a door or a sunroof of the vehicle 4, and changes a light transmittance in response to an on-off state of a power supply under the control of the ECU 41. Specifically, the dimming glass 44 is switched from a light-blocking state to a transparent state in response to the on-off state of the power supply under the control of the ECU 41. It should be noted that, in Embodiment 1, the dimming glass 44 is assumed, but a dimming film capable of changing the transmittance in response to the on-off state of the power supply or a liquid crystal film may be used.

The measurement unit 45 is configured by using a timer, a sensor that detects a driving state of the drive device 43, or the like, measures a time elapsed since the vehicle 4 is stopped, and outputs the measurement result to the ECU 41.

The voice output unit 46 is configured by using a speaker, a DA conversion circuit, an amplifier, and the like, and outputs various types of information under the control of the ECU 41. The voice output unit 46 converts, for example, digital voice data input from the ECU 41 into analog voice data and outputs the analog voice data to the outside.

The display device 47 is realized by, for example, a liquid crystal display (LCD) or an organic EL display (OLED), is provided in a vehicle cabin of the vehicle 4, and functions as an in-vehicle display. The display device 47 displays various types of information under the control of the ECU 41.

The input unit 48 is realized by, for example, a touch panel, a keyboard, or a pointing device. The input unit 48 receives an input of various operations by the user and outputs a signal corresponding to the received operation to the ECU 41.

The communication unit 49 is configured by, for example, a data communication module (DCM). The communication unit 49 exchanges information with the vehicle information server 3 by communication through the network N.

### Terminal Device

Next, the terminal device 5 will be described. The terminal device 5 is, for example, an information processing terminal such as a mobile phone. The terminal device 5 receives an input of various operations by the debtor.

### Exchange of Information in Each Device of Vehicle Control System

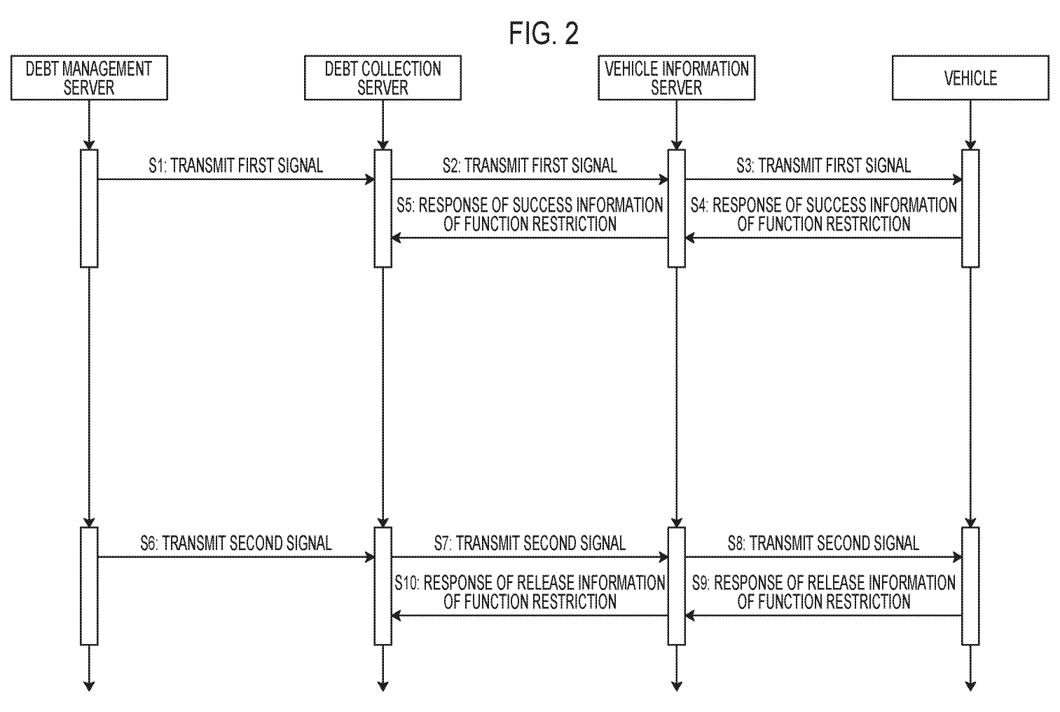

Next, the exchange of information in the debt collection server 1, the debt management server 2, the vehicle information server 3, and the vehicle 4 will be described. FIG. 2 is a sequence diagram showing an example of the exchange of information between the debt collection server 1, the debt management server 2, the vehicle information server 3, and the vehicle 4. It should be noted that, in the following processing, processing in a case of being performed on the vehicle 4 (target vehicle) used by the debtor in which a delay in payment for the debt has occurred among the vehicles 4 will be described as an example.

As shown in FIG. 2, first, in a case in which the controller 11 of the debt collection server 1 receives the first signal from the debt management server 2 (S1), the controller 11 transmits the first signal to the vehicle information server 3 (S2). Subsequently, the vehicle information server 3 transmits the first signal received from the debt collection server 1 to the vehicle 4 (S3). In response to this, the ECU 41 of the vehicle 4 restricts some of functions of the vehicle 4 and performs a response of the success information of the function restriction of the vehicle 4 to the vehicle information server 3 (S4). The restriction content of some of the functions of the vehicle 4 by the ECU 41 will be described below. Thereafter, the vehicle information server 3 transmits the response of the success information of the function restriction received from the vehicle 4 to the debt collection server 1 (S5). In this case, the debt collection server 1 accumulates the success information of the function restriction of the vehicle 4 received from the vehicle information server 3 and the vehicle identification number (VIN number) of the vehicle 4 in association with each other in the vehicle history DB 12.

Next, in a case in which the controller 11 of the debt collection server 1 receives the second signal from the debt management server 2 (S6), the controller 11 transmits the second signal to the vehicle information server 3 (S7). Subsequently, the vehicle information server 3 transmits the second signal received from the debt collection server 1 to the vehicle 4 (S8). In response to this, the ECU 41 of the vehicle 4 releases the restriction of some of the functions of the vehicle 4 and performs a response of the release information of the function restriction to the vehicle information server 3 (S9). In this case, as a result, the debtor can use the vehicle 4 in a state in which the restriction of the functions of the vehicle 4 is not performed. Subsequently, the vehicle information server 3 transmits the response of the release information received from the vehicle 4 to the debt collection server 1 (S10). In this case, the debt collection server 1 accumulates the release information received from the vehicle information server 3 and the vehicle identification number (VIN number) of the vehicle 4 in association with each other in the vehicle history DB 12.

### Processing in Debt Collection Server

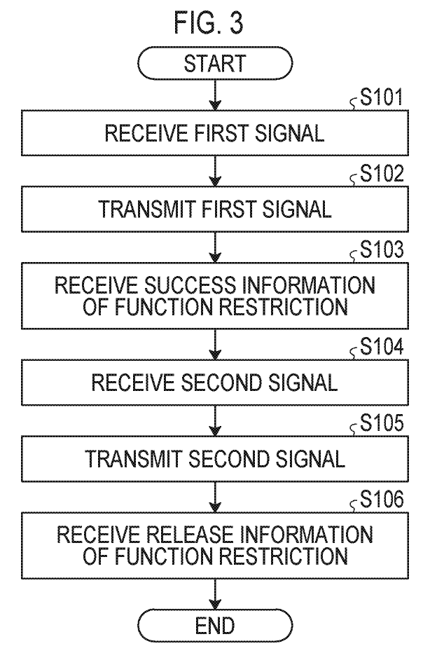

Next, processing executed by the debt collection server 1 will be described. FIG. 3 is a flowchart showing an outline of processing executed by the debt collection server 1.

As shown in FIG. 3, in a case in which the controller 11 receives the first signal from the debt management server 2 (S101), the controller 11 transmits the first signal from the debt management server 2 to the vehicle information server 3 (S102). The controller 11 receives the success information of the function restriction of the vehicle 4 from the vehicle information server 3 (S103).

Subsequently, in a case in which the controller 11 receives the second signal from the debt management server 2 (S104), the controller 11 transmits the second signal to the vehicle information server 3 (S105) and receives the release information from the vehicle information server 3 (S106). After S106, the debt collection server 1 ends the processing.

### Processing of Vehicle Information Server

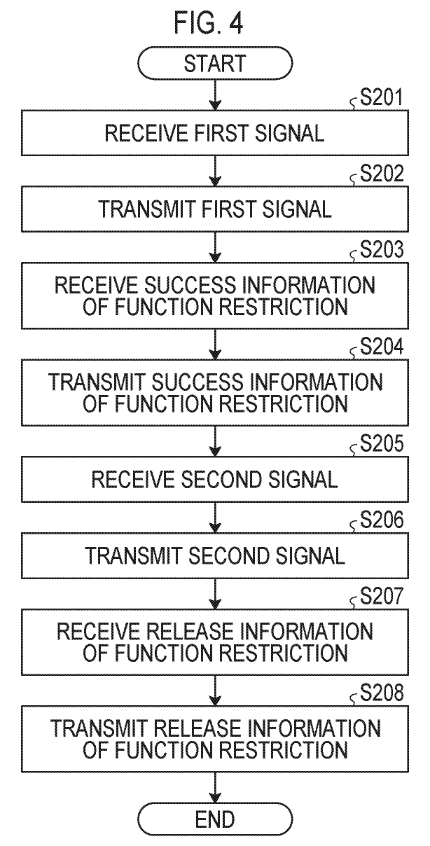

Next, an outline of processing executed by the vehicle information server 3 will be described. FIG. 4 is a flowchart showing an outline of processing executed by the vehicle information server 3.

As shown in FIG. 4, first, the controller 31 receives the first signal from the debt collection server 1 (S201) and transmits the received first signal to the vehicle 4 (S202).

Subsequently, the controller 31 receives the success information of the function restriction of the vehicle 4 from the vehicle 4 (S203) and transmits the received success information of the function restriction of the vehicle 4 to the debt collection server 1 (S204).

Subsequently, the controller 31 receives the second signal from the debt collection server 1 (S205) and transmits the received second signal to the vehicle 4 (S206).

Subsequently, the controller 31 receives the release information from the vehicle 4 (S207) and transmits the received release information to the debt collection server 1 (S208). After S208, the vehicle information server 3 ends the processing.

### Processing of Vehicle

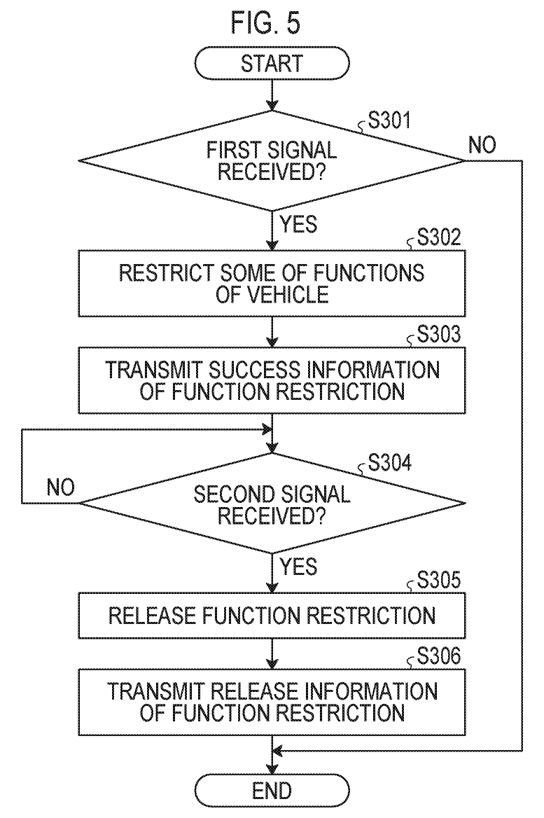

Next, an outline of processing executed by the vehicle 4 will be described. FIG. 5 is a flowchart showing an outline of processing executed by the vehicle 4.

As shown in FIG. 5, first, in a case in which the ECU 41 receives the first signal from the vehicle information server 3 (S301: Yes), the ECU 41 restricts some of functions of the vehicle 4 (S302). Specifically, the ECU 41 restricts at least one function of the vehicle 4 from the following (1) to (4).

### 1.

The ECU 41 controls the drive device 43 to stop or park the vehicle 4 at a position away from the destination designated by the user (debtor) via the input unit 48 using the car navigation system 42 by a predetermined distance. Here, the position away from the destination by the predetermined distance is, for example, a position away from the destination by about 300 to 500 m. It should be noted that the ECU 41 can appropriately change the position away from the destination by the predetermined distance, and for example, can change and set the position to be farther from the destination as the debt amount of the user (debtor) is larger. In this case, the ECU 41 displays a message indicating that the vehicle 4 is stopped or parked at the position away from the destination by the predetermined distance on the display device 47 or the terminal device 5. As a result, the user (debtor) cannot stop or park the vehicle 4 at the desired destination, which is inconvenient. As a result, the creditor can prompt the user (debtor) to make a payment for the debt.

### 2.

In addition, the ECU 41 controls the drive device 43 to stop or park the vehicle 4 at a position away from the pickup and drop-off location designated by the user via the terminal device 5 by a predetermined distance. Here, the position away from the pickup and drop-off location by the predetermined distance is, for example, a position away from the pickup and drop-off location by about 300 to 500 m. It should be noted that the ECU 41 can appropriately change the position away from the pickup and drop-off location by the predetermined distance, and for example, can change and set the position to be farther from the pickup and drop-off location as the debt amount of the user (debtor) is larger. In this case, the ECU 41 displays a message indicating that the vehicle 4 is stopped or parked at the position away from the pickup and drop-off location by the predetermined distance on the display device 47 or the terminal device 5. As a result, the user (debtor) cannot stop or park the vehicle 4 at the desired pickup and drop-off location, which is inconvenient. That is, the user (debtor) feels inconvenient because the vehicle 4 does not go to the destination or the vehicle 4 is parked at a location far from the entrance of the destination. As a result, the creditor can prompt the user (debtor) to make a payment for the debt.

### 3.

In addition, the ECU 41 controls the on-off state of the power supply of the dimming glass 44 provided in the window or the sunroof of the vehicle 4 to always set the dimming glass 44 to the light-blocking state or the transparent state. For example, in a case in which the user (debtor) designates the transparent state of the dimming glass 44 via the input unit 48, the ECU 41 controls the dimming glass 44 to be in the light-blocking state by turning on the power supply of the dimming glass 44. On the other hand, in a case in which the user (debtor) designates the light-blocking state of the dimming glass 44 via the input unit 48, the ECU 41 controls the dimming glass 44 to be in the transparent state by turning off the power supply of the dimming glass 44. As a result, the user (debtor) cannot switch the state of the window even in a case in which the user (debtor) wants to switch the state of the window at a desired timing, which is inconvenient. That is, the user (debtor) feels inconvenient because the vehicle 4 does not come to the front of the house designated by the user (debtor) or the vehicle 4 does not go to the designated place even in a case in which the user (debtor) designates a place to get on the vehicle 4. As a result, the creditor can prompt the user (debtor) to make a payment for the debt.

### 4.

In addition, the ECU 41 controls the drive device 43 to move to a predetermined location in a case in which the vehicle 4 is not being used. Specifically, in a case in which a time measured by the measurement unit 45 since the time at which the vehicle 4 is stopped at a predetermined location, for example, a parking lot of the house of the user (debtor) is a predetermined time, for example, one hour, the ECU 41 determines that the vehicle 4 is not being used, and drives the drive device 43 to move to the parking lot managed by the creditor. In addition, in a case of a night in which the vehicle 4 is not used, the ECU 41 determines that the vehicle 4 is not being used, and drives the drive device 43 to move to the parking lot managed by the creditor. It should be noted that the ECU 41 may drive the drive device 43 to move to a place designated by the creditor in addition to the parking lot managed by the creditor. In this case, the ECU 41 may transmit a message indicating that the vehicle 4 is moved to the terminal device 5.

As described above, the ECU 41 restricts at least one function from (1) to (4) above. As a result, the debtor can be prompted to make a payment for the debt.

Subsequently, the ECU 41 restricts some of functions of the vehicle 4 and transmits the success information of the function restriction of the vehicle 4 to the vehicle information server 3 (S303).

Subsequently, the ECU 41 determines whether the second signal is received from the vehicle information server 3 (S304). In a case in which determination is made by the ECU 41 that the second signal is received from the vehicle information server 3 (S304: Yes), the vehicle 4 proceeds to S305. On the other hand, in a case in which determination is made by the ECU 41 that the second signal is not received from the vehicle information server 3 (S304: No), the vehicle 4 repeats the determination.

Subsequently, the ECU 41 releases the function restriction of the function of the vehicle 4 (S305) and transmits the release information of the function restriction to the vehicle information server 3 (S306). After S306, the vehicle 4 ends the processing.

According to Embodiment 1 described above, in a case in which the first signal is received, the ECU 41 restricts some of the functions of the vehicle 4 capable of autonomous driving, so that the debtor can be prompted to make a payment for the debt.

In addition, according to Embodiment 1, the ECU 41 controls the drive device 43 to stop or park the vehicle 4 at a position away from the destination designated by the user (debtor) via the input unit 48 using the car navigation system 42 by a predetermined distance. Therefore, the user (debtor) cannot stop or park the vehicle 4 at the desired destination, which is inconvenient, so that the debtor can be prompted to make a payment for the debt.

In addition, according to Embodiment 1, the ECU 41 controls the drive device 43 to stop or park the vehicle 4 at a position away from the pickup and drop-off location designated by the user via the terminal device 5 by a predetermined distance. Therefore, the user (debtor) cannot stop or park the vehicle 4 at the desired pickup and drop-off location, which is inconvenient, so that the debtor can be prompted to make a payment for the debt.

In addition, according to Embodiment 1, the ECU 41 controls the on-off state of the power supply of the dimming glass 44 provided in the window or the sunroof of the vehicle 4 to always set the dimming glass 44 to the light-blocking state or the transparent state. Therefore, the user cannot switch the state of the window even in a case in which the user wants to switch the state of the window at a desired timing, which is inconvenient, so that the debtor can be prompted to make a payment for the debt.

In addition, according to Embodiment 1, the ECU 41 controls the drive device 43 to move to a predetermined location in a case in which the vehicle 4 is not being used. As a result, even in a case in which the user wants to use the vehicle 4 at a desired timing, the user has to designate the vehicle 4 at the pickup and drop-off location again, which is inconvenient, so that the debtor can be prompted to make a payment for the debt.

### Embodiment 2

Next, Embodiment 2 will be described. In Embodiment 1, in a case in which the ECU 41 of the vehicle 4 receives the first signal, some of the functions of the vehicle 4 is restricted, but in Embodiment 2, the controller 11 of the debt collection server 1 performs the same processing by remote control. That is, in Embodiment 2, the controller 11 functions as the vehicle control device. Hereinafter, processing executed by the debt collection server 1 according to Embodiment 2 will be described.

### Processing of Debt Collection Server

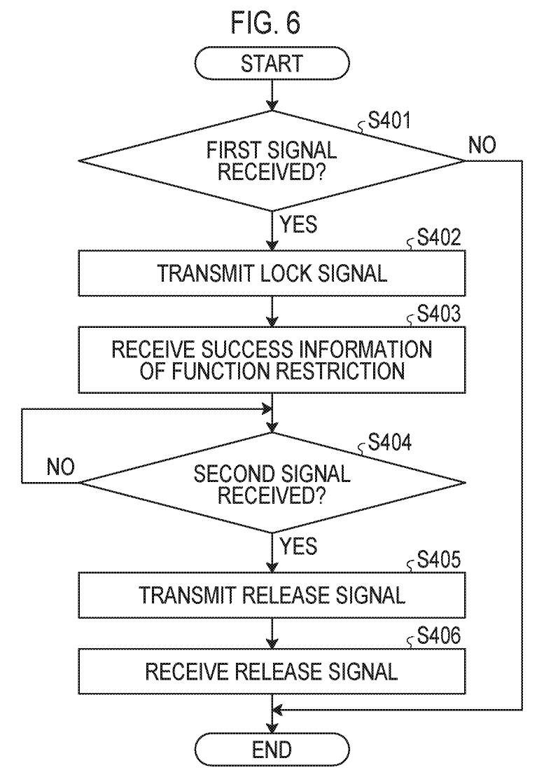

FIG. 6 is a flowchart showing an outline of processing executed by the debt collection server 1 according to Embodiment 2. It should be noted that, in Embodiment 2, the controller 11 of the debt collection server 1 functions as the processor of the vehicle control device.

As shown in FIG. 6, in a case in which the controller 11 receives the first signal from the debt management server 2 (S401), the controller 11 transmits a lock signal for restricting some of the functions of the vehicle 4 by remote control to the vehicle 4 via the vehicle information server 3 (S402). In this case, the ECU 41 of the vehicle 4 restricts some of the functions of the vehicle 4 in response to the lock signal by the remote control from the debt collection server 1. Specifically, the ECU 41 of the vehicle 4 restricts at least one function from (1) to (4) described above in Embodiment 1 in response to the lock signal by the remote control from the debt collection server 1. It should be noted that, in Embodiment 2, the controller 11 functions as the processor of the vehicle control device.

Subsequently, the controller 11 receives the success information of the function restriction of the vehicle 4 from the vehicle 4 via the vehicle information server 3 (S402).

Subsequently, the controller 11 determines whether the second signal is received from the debt management server 2 (S403). In a case in which determination is made by the controller 11 that the second signal is received from the debt management server 2 (S404: Yes), the debt collection server 1 proceeds to S405. On the other hand, in a case in which determination is made by the controller 11 that the second signal is not received from the debt management server 2 (S404: No), the debt collection server 1 repeats the determination.

Subsequently, the controller 11 transmits a release signal for releasing the function restriction of the vehicle 4 by remote control to the vehicle 4 via the vehicle information server 3 (S405). In this case, the ECU 41 of the vehicle 4 releases the function restriction of the function of the vehicle 4 in response to the release signal by the remote control from the debt collection server 1. In this case, the controller 11 may display the fact that the function restriction of the vehicle 4 is released on the display device 47 of the vehicle 4 by remote control via the vehicle information server 3, or may transmit the fact to the terminal device 5 to display the fact.

Subsequently, the controller 11 receives the release information of the function restriction from the vehicle 4 via the debt management server 2 (S406). After S406, the debt collection server 1 ends the processing.

According to Embodiment 2 described above, as in Embodiment 1, in a case in which the first signal is received, the controller 11 restricts some of the functions of the vehicle 4 by remote control, so that the debtor can be prompted to make a payment for the debt.

### Other Embodiments

Further effects and modifications can be easily derived by those skilled in the art. Therefore, the broader aspects of the present disclosure are as described above, and are not limited to the specific details and representative embodiments described above. Therefore, various modifications can be made without departing from the spirit or scope of the overall disclosure defined by the appended claims and their equivalents.

For example, in Embodiments 1 and 2, the description has been made on the premise that the debt collection server 1 or the vehicle 4 is used, but the debt management server 2 or the vehicle information server 3 itself may have the functions of the controller 11 or the ECU 41. In this case, the debt management server 2 or the vehicle information server 3 may have the functions of the controller 11 of the debt collection server 1 or the vehicle history DB 12. In addition, in the vehicle control device according to Embodiments 1 and 2, the vehicle 4 may perform a part of the processing of the debt collection server 1 or the vehicle information server 3.

In addition, in the embodiment of the present disclosure, the debt collection server 1, the debt management server 2, and the vehicle information server 3 have been described as separate devices, respectively. However, the debt collection server 1, the debt management server 2, and the vehicle information server 3 may be configured by one or two or four or more devices.

What is claimed is:

1. A vehicle control device comprising a processor configured to perform, in a case where a first signal indicating that a debt for a target vehicle configured to perform autonomous driving is not correctly paid is received from a debt management server that manages the debt for the target vehicle, control in response to reception of the first signal such that the target vehicle is stopped or parked at a position a predetermined distance away from a destination designated for the target vehicle.

2. A vehicle control device comprising a processor configured to restrict, in a case where a first signal indicating that a debt for a target vehicle configured to perform autonomous driving is not correctly paid is received, some of functions of the target vehicle in response to reception of the first signal.

3. The vehicle control device according to claim 2, wherein restricting the some of the functions includes performing control such that the target vehicle is stopped or parked at a position a predetermined distance away from a destination designated for the target vehicle.

4. The vehicle control device according to claim 2, wherein restricting the some of the functions includes performing control such that the target vehicle is stopped or parked at a position a predetermined distance away from a pickup and drop-off location designated for the target vehicle.

5. The vehicle control device according to claim 2, wherein restricting the some of the functions includes performing control such that a dimming film or a dimming glass provided in a window or a sunroof of the target vehicle is always kept in a light-blocking state or in a transparent state, the dimming film or the dimming glass being configured to change a light transmittance in response to an on-off state of a power supply.

6. The vehicle control device according to claim 2, wherein restricting the some of the functions includes performing, in a case where the target vehicle is not being used by a user, control such that the target vehicle moves to a predetermined location.

7. The vehicle control device according to claim 2, wherein the processor is configured to output a lock signal for restricting the some of the functions of the target vehicle to the target vehicle in response to the reception of the first signal to perform remote control.
